(19) United States
(12) Patent Application Publication
(10) Pub. No.: US 2012/0198007 A1
(43) Pub. Date: Aug. 2, 2012

(54) Electronic Apparatus, Communication Control Method and Communication Control System

(76) Inventor: Yuji Fujiwara, Hamura-shi (JP)

(21) Appl. No.: 13/238,920

(22) Filed: Sep. 21, 2011

(30) Foreign Application Priority Data
Jan. 31, 2011 (JP) 2011-018965

(51) Int. Cl. G06F 15/16

(52) U.S. Cl. 709/206

(57) ABSTRACT

According to one embodiment, an electronic apparatus includes a first storage, a second storage and a control module. The first storage stores a destination list including a first address indicating a destination of a first e-mail which has already transmitted. The second storage stores at least one of a white list and a black list, the white list including an address to which transmission of an e-mail is permitted, the black list including an address to which transmission of an e-mail is blocked. The control module blocks transmission of a second e-mail to a second address if the second address is not included in the white list or the second address is included in the black list in a block mode and issues an alert on the transmission of the second e-mail to the second address if the second address is not included in the destination list.

### CROSS-REFERENCE TO RELATED APPLICATIONS

This application is based upon and claims the benefit of priority from prior Japanese Patent Application No. 2011-018965, filed Jan. 31, 2011, the entire contents of which are incorporated herein by reference.

### FIELD

Embodiments described herein relate generally to an electronic apparatus having a communication function, a communication control method which is applied to the apparatus, and a communication control system.

### BACKGROUND

In various kinds of electronic apparatuses with communication functions, such as personal computers, mobile phones and smartphones, information can easily be transmitted/received by using electronic mails (e-mails). When sending an e-mail, a user inputs an e-mail address corresponding to a destination to which the e-mail is to be sent. The user inputs the e-mail address of the destination, for example, by an input with use of a keyboard, or by selecting an e-mail address from an address book including pre-registered e-mail addresses.

In the input of the e-mail address by the user, it is possible that an e-mail address of a destination, which is different from the destination to which an e-mail is to be transmitted, or an e-mail address including a typographical error may be input. Thus, in order to prevent an e-mail from being transmitted to an erroneously input e-mail address, various techniques have been proposed.

For example, a method using a white list including riskless e-mail addresses has been proposed. In this method, a confirmation screen is displayed to prompt a user to confirm whether or not to transmit an e-mail when an e-mail address, which has been input by a user as a destination, is not included in the white list. In addition, a method storing destination addresses of previously transmitted e-mails has been proposed. In this method, a confirmation screen is displayed when a destination address of an e-mail, which is to be newly transmitted, is not included in the stored destination addresses.

However, since the user is accustomed to the display of the confirmation screen with only the above methods, the user may continue the procedure of transmitting the e-mail without confirming the content of the confirmation screen. In addition, in the method storing the destination addresses of previously transmitted e-mails, the confirmation screen is displayed each time an e-mail is to be transmitted, in the initial state. In the initial state, since no e-mails are transmitted, the operation by the user may become time-consuming. Therefore, suitable methods for controlling the transmission of e-mails vary depending on usage situations of e-mails by the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary conceptual view illustrating an example of the structure of a communication control system according to a first embodiment.

FIG. 2 is an exemplary conceptual view illustrating another example of the structure of the communication control system of the first embodiment.

FIG. 3 is an exemplary block diagram showing an example of the system configuration of the communication control system of the first embodiment.

FIG. 4 shows exemplary operation modes of the communication control system of the first embodiment.

FIG. 5 shows an example of a destination address list which is used by the communication control system of the first embodiment.

FIG. 6 shows an example of a white list which is used by the communication control system of the first embodiment.

FIG. 7 shows an example of a black list which is used by the communication control system of the first embodiment.

FIG. 8 shows an example of the structure of group information which is used by the communication control system of the first embodiment.

FIG. 9 shows an example of the structure of delivery list information which is used by the communication control system of the first embodiment.

FIG. 10 shows an example of a setup screen which is displayed by the communication control system of the first embodiment.

FIG. 11 shows an example of a description of a destination list which is delivered by the communication control system of the first embodiment.

FIG. 12 shows another example of the description of the destination list which is delivered by the communication control system of the first embodiment.

FIG. 13 shows an example of an e-mail address indicative of the destination of an e-mail, the transmission of which is controlled by the communication control system of the first embodiment.

FIG. 14 shows an example of a select screen which is displayed by the communication control system of the first embodiment.

FIG. 15 shows an example of a confirmation screen which is displayed by the communication control system of the first embodiment.

FIG. 16 shows another example of the confirmation screen which is displayed by the communication control system of the first embodiment.

FIG. 17 shows still another example of the confirmation screen which is displayed by the communication control system of the first embodiment.

FIG. 18 is an exemplary flowchart illustrating an example of the procedure of a list delivery process which is executed by the communication control system of the first embodiment.

FIG. 19 is an exemplary flowchart illustrating an example of the procedure of a transmission control process which is executed by the communication control system of the first embodiment.

FIG. 20 is an exemplary flowchart illustrating an example of the procedure of a monitoring process which is executed by the communication control system of the first embodiment.

FIG. 21 is an exemplary flowchart illustrating an example of the procedure of an alert process which is executed by the communication control system of the first embodiment.

FIG. 22 is an exemplary flowchart illustrating an example of the procedure of a block process which is executed by the communication control system of the first embodiment.

FIG. 23 is an exemplary perspective view showing the external appearance of an electronic apparatus according to a second embodiment.

FIG. 24 is an exemplary block diagram showing the system configuration of the electronic apparatus of the second embodiment.

FIG. 25 is an exemplary block diagram showing the functional structure of an e-mail transmission control program which is executed by the electronic apparatus of the second embodiment.

### DETAILED DESCRIPTION

Various embodiments will be described hereinafter with reference to the accompanying drawings.

In general, according to one embodiment, an electronic apparatus includes a first list storage module, a second list storage module and a transmission control module. The first list storage stores a destination address list including a first destination electronic mail address indicative of a destination of a first electronic mail which has already transmitted. The second list storage stores at least one of a white list and a black list, the white list including a permit electronic mail address to which transmission of an electronic mail is permitted, the black list including a block electronic mail address to which transmission of an electronic mail is blocked. The transmission control module blocks transmission of a second electronic mail to a second destination electronic mail address if the second destination electronic mail address is not included in the white list or the second destination electronic mail address is included in the black list in a block mode and issues an alert on the transmission of the second electronic mail to the second destination electronic mail address if the second destination electronic mail address is not included in the destination address list in an alert mode.

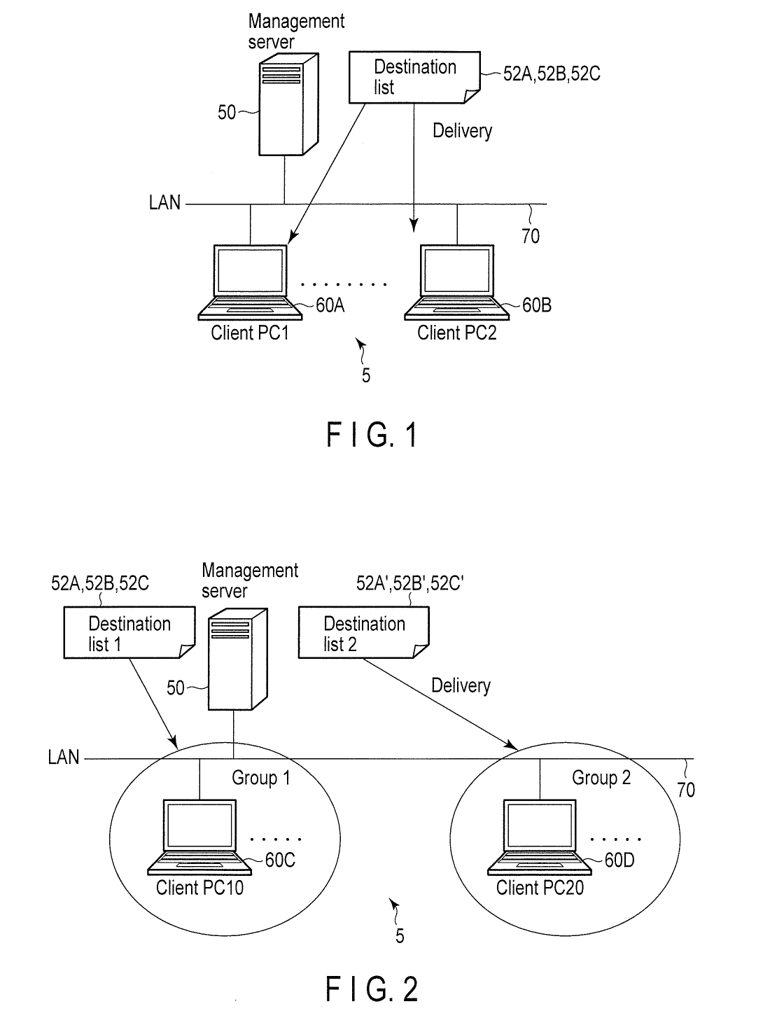

FIG. 1 shows an example of the structure of a communication control system 5 according to a first embodiment. In the example shown in FIG. 1, the communication control system 5 includes a management server (server device) 50 and a plurality of client computers (client devices) 60A, 60B. The management server 50 and client computers 60A, 60B are interconnected via a network 70 such as a local area network (LAN). The management server 50 delivers a destination list 52A, 52B, 52C to the client computer 60A, 60B via the network 70. The destination list 52A, 52B, 52C is a list of electronic mail (e-mail) addresses. The destination list 52A, 52B, 52C is used in order to control the transmission of e-mails which are sent by the client computer 60A, 60B. The client computer 60A, 60B controls the transmission of an e-mail, the transmission of which has been instructed, by using the destination list 52A, 52B, 52C which is delivered by the management server 50.

FIG. 2 shows another example of the structure of the communication control system 5. In the example shown in FIG. 2, the communication control system 5 includes a management server (server device) 50 and a plurality of client computers (client devices) 60C, 60D. Like the example shown in FIG. 1, the management server 50 and client computers 60C, 60D are interconnected via a network 70 such as a local area network (LAN). The client computers 60C, 60D belong to respective associated groups. The client computer 60C belongs to a group 1. The client computer 60D belongs to a group 2. The group refers to, for instance, a group such as a department of a company or a department of a university. By managing the client computer 60C, 60D in units of the group to which the client computer belongs, the management server 50 can deliver different destination lists to the client computer 60C which belongs to the group 1 and the client computer 60D which belongs to the group 2. Accordingly, the client computer 60C controls the transmission of an e-mail, the transmission of which has been instructed, by using the destination lists 52A, 52B and 52C delivered by the management server 50. In addition, the client computer 60D controls the transmission of an e-mail, the transmission of which has been instructed, by using destination lists 52A′, 52B′ and 52C′ delivered by the management server 50.

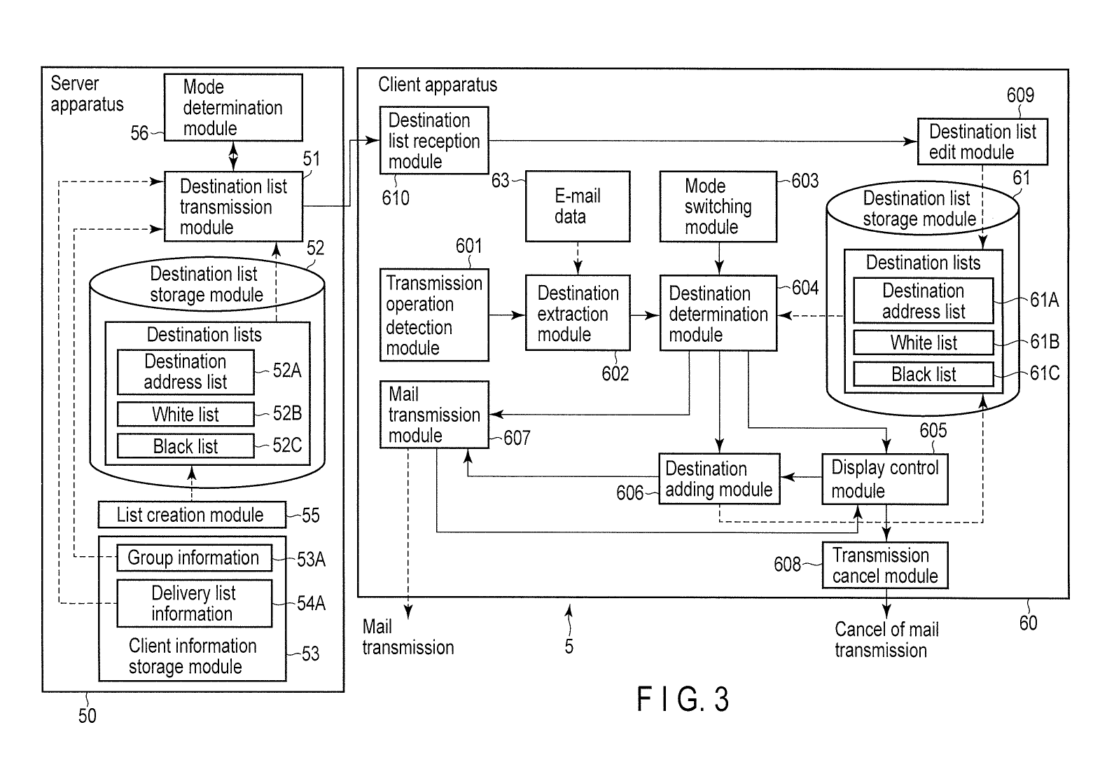

Next, FIG. 3 shows the system configuration of the communication control system 5. The communication control system 5, as described above, includes the server device 50 and one or more client devices 60. The server device 50 and client devices 60 are interconnected via the network 70. The server device 50 can be realized by, for example, a server computer. The client device 60 can be realized by, for example, a personal computer.

The server device 50 includes a destination list transmission module 51, a destination list storage module 52, a client information storage module 53, a list creation module 55, and a mode determination module 56. The destination list storage module 52 stores a destination address list 52A, a white list 52B and a black list 52C. The destination address list 52A includes destination e-mail addresses indicative of destinations of previously sent e-mails. The white list 52B includes e-mail addresses, the transmission of an e-mail to which is permitted. The black list 52C includes e-mail addresses, the transmission of an e-mail to which is blocked. The client information storage module 53 stores group information 53A and delivery list information 54A. The group information 53A includes an entry indicative of the correspondence between the client device 60 and the group to which this client device 60 belongs. The delivery list information 54A includes an entry indicative of the correspondence between a group and a list which is delivered to this group. The destination list storage module 52 and client information storage module 53 are, for example, predetermined memory areas in a storage device such as an HDD.

The client device 60 includes a transmission operation detection module 601, a destination extraction module 602, a mode switching module 603, a destination determination module 604, a display control module 605, a destination adding module 606, a mail transmission module 607, a transmission cancel module 608, a destination list edit module 609, a destination list reception module 610, and a destination list storage module 61. The destination list storage module 61 stores a destination address list 61A, a white list 61B and a black list 61C. The destination address list 61A includes destination e-mail addresses indicative of destinations of previously sent e-mails. The white list 61B includes e-mail addresses, the transmission of an e-mail to which is permitted. The black list 61C includes e-mail addresses, the transmission of an e-mail to which is blocked. The destination list storage module 61 is, for example, a predetermined memory area in a storage device such as an HDD.

The server device 50 transmits the mode information and the destination lists 52A, 52B and 52C to the client device 60 to control an e-mail, the transmission of which has been instructed in the client device 60. The mode information indicates an operation mode of the client device 60. The destination lists 52A, 52B and 52C are used in the operation mode. The client device 60 operates in the operation mode, and executes a predetermined process on the e-mail by using the destination lists 52A, 52B and 52C (i.e. the destination lists 61A, 61B and 61C being updated by using the destination lists 52A, 52B and 52C).

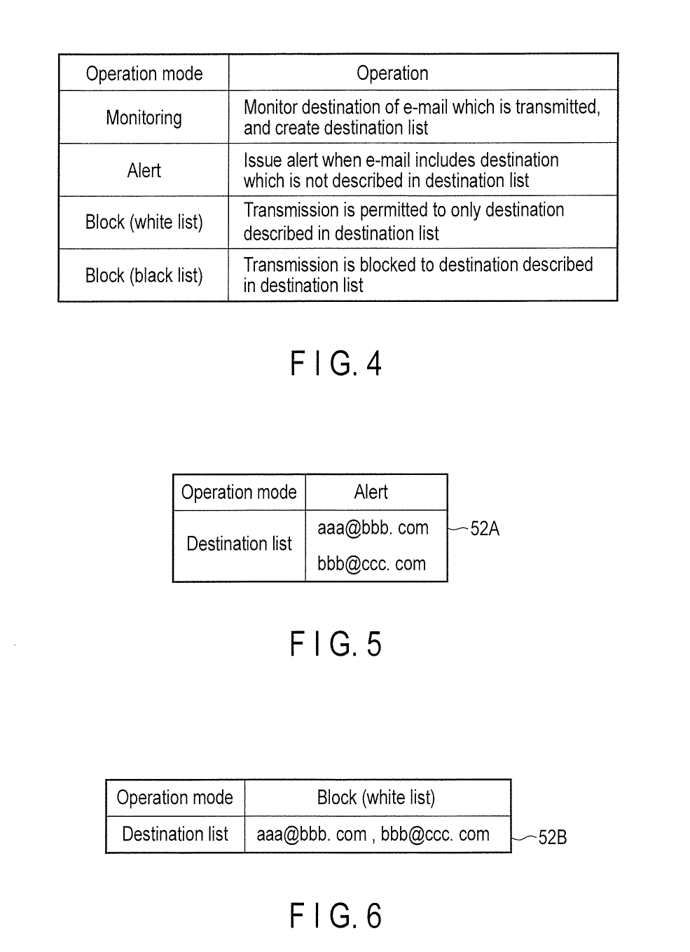

FIG. 4 shows examples of the operation modes of the client device 60. The operation modes include, for instance, a monitoring mode, an alert mode, a block mode by white list, and a block mode by black list. In the monitoring mode, a destination e-mail address indicative of a destination of an e-mail, the transmission of which has been instructed, is added to the destination address list 61A. In the alert mode, an alert is issued on the transmission of an e-mail to an e-mail address which is not included in the destination address list 61A. In the block mode by white list, the transmission of an e-mail to an e-mail address, which is not included in the white list 61A, is blocked. In the block mode by black list, the transmission of an e-mail to an e-mail address, which is included in the black list 61C, is blocked.

Specifically, to begin with, the list creation module 55 of the server device 50 creates the destination address list 52A, white list 52B and black list 52C.

FIG. 5 shows an example of the destination address list 52A. The destination address list 52A includes an e-mail address (also referred to as “address”) corresponding to the destination (destination of transmission) of a previously sent e-mail. In addition, the destination address list 52A includes mode information indicative of the operation mode in which this list is used. The destination address list 52A is used in the monitoring mode or alert mode. In the example shown in FIG. 5, the destination address list 52A includes e-mail addresses, “aaa@bbb.com” and “bbb@ccc.com”. In addition, the destination address list 52A includes mode information indicating that the destination address list 52A is used in the “Alert mode”. In the initial state in which the monitoring of addresses of e-mails is started in the monitoring mode, the destination address list 52A may be an empty list including no e-mail address.

FIG. 6 shows an example of the white list 52B. The white list 52B includes an e-mail address, the transmission of an e-mail to which is permitted. In addition, the white list 52B includes mode information indicating that the white list 52B is used in the block mode (the block mode by white list). In the example shown in FIG. 6, the white list 52B includes e-mail addresses, “aaa@bbb.com” and “bbb@ccc.com”. The white list 52B includes mode information indicating that the white list 52B is used in the “Block mode by white list”. In the meantime, the white list 52B may include a domain name, the transmission of an e-mail to which is permitted.

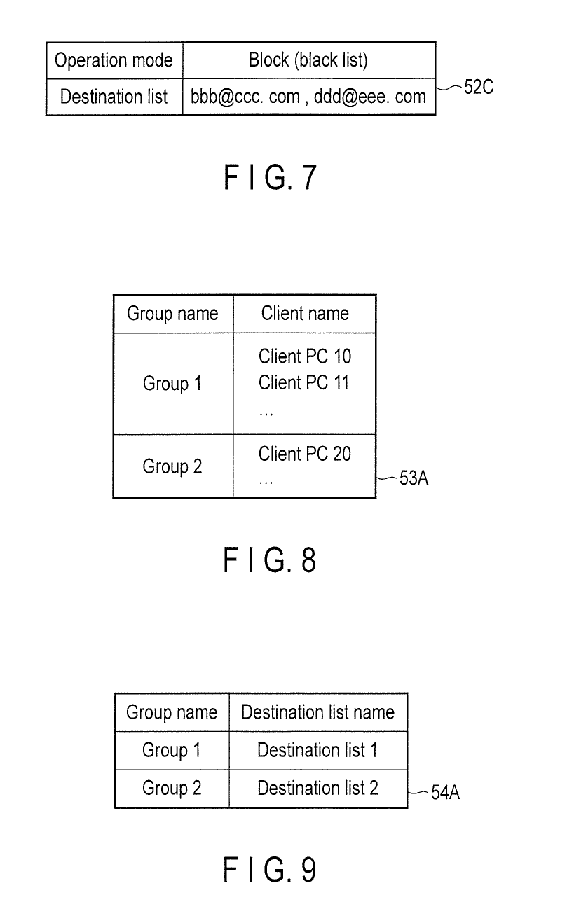

FIG. 7 shows an example of the black list 52C. The black list 52C includes an e-mail address, the transmission of an e-mail to which is blocked. In addition, the black list 52C includes mode information indicating that the black list 52C is used in the block mode (the block mode by black list). In the example shown in FIG. 7, the black list 52C includes e-mail addresses, “bbb@ccc.com” and “ddd@eee.com”. The black list 52C includes mode information indicating that the black list 52C is used in the “Block mode by black list”. In the meantime, the black list 52C may include a domain name, the transmission of an e-mail to which is blocked.

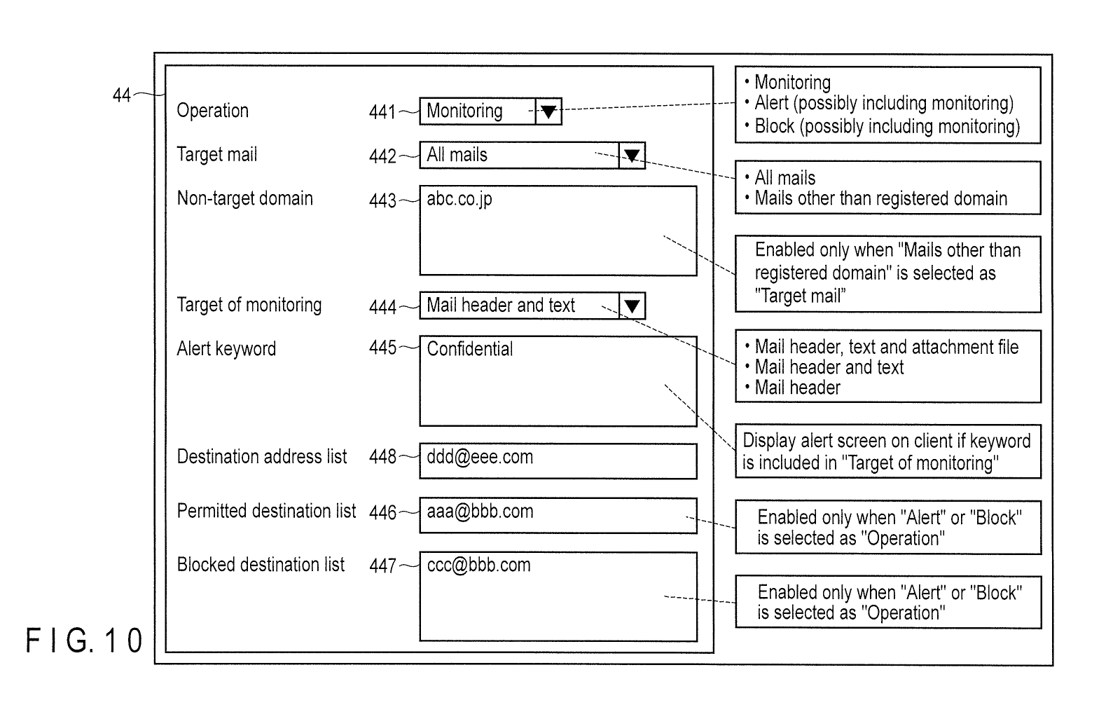

The list creation module 55 creates the destination address list 52A, white list 52B and black list 52C by using e-mail addresses which are input by, for example, a system administrator. The list creation module 55 outputs the created destination address list 52A, white list 52B and black list 52C (hereinafter also referred to as “lists 52A, 52B and 52C”) to the destination list storage module 52. The destination list storage module 52 stores the lists 52A, 52B and 52C which have been output by the list creation module 55. The system administrator creates the lists 52A, 52B and 52C by inputting e-mail addresses by using, for example, a setup screen 44 which will be described later with reference to FIG. 10. In addition, the list creation module 55 may create the destination address list 52A by using destination e-mail addresses indicative of the destinations of e-mails which were previously sent by the client device 60.

Besides, the list creation module 55 also creates the lists 52A, 53B and 53C which are different between groups based on the group information 53A and delivery list information 54A.

FIG. 8 shows a structure example of the group information 53A. The group information 53A includes a plurality of entries corresponding to a plurality of groups. Each entry includes, for example, a group name and a client name. In the entry corresponding to a certain group, “Group name” is indicative of a name which is given to the group. “Client name” is indicative of a name of a client device (client computer) belonging to the group. Thus, by using the group information 53A, the group, to which a certain client belongs, can be specified. In the example shown in FIG. 8, it is indicated that “Client PC 10” and “Client PC 11” belong to “Group 1”, and “Client PC 20” belongs to “Group 2”. The group is used as a unit such as a department of a company or a department of a university.

FIG. 9 shows a structure example of the delivery list information 54A. The delivery list information 54A includes a plurality of entries corresponding to a plurality of groups. Each entry includes, for example, a group name and a destination list name. In the entry corresponding to a certain group, “Group name” is indicative of a name which is given to the group. “Destination list name” is indicative of a name of a list which is delivered to the group (i.e. a list which is delivered to a client device belonging to the group). Thus, by using the delivery list information 54A, the list, which is delivered to a certain group, can be specified. In the example shown in FIG. 9, it is indicated that “Destination list 1” is delivered to the client device belonging to “Group 1”, and “Delivery list 2” is delivered to the client device belonging to “Group 2”. Specifically, the server device 50 can deliver to the client devices 60 the destination lists 52A, 52B and 52C which are different between the groups.

Using the above-described group information 53A and delivery list information 54A, the list creation module 55 creates the lists 52A, 52B and 52C which are suited to each group. The created lists 52A, 52B and 52C are stored in the destination list storage module 52. Thus, a plurality of lists 52A, 52B and 52C corresponding to a plurality of groups are stored in the destination list storage module 52. For example, the list creation module 55 creates the destination lists 52A, 52B and 52C for the respective groups corresponding to, e.g. departments. Therefore, a plurality of client devices 60 belonging to each group can control the transmission of e-mails with use of the destination lists 52A, 52B and 52C which are common to the plurality of client devices 60.

In addition, the destination list transmission module 51 delivers the lists 52A, 52B and 52C, which are stored in the destination list storage module 52, to the client device 60. To be more specific, at a timing when the lists 52A, 52B and 52C are delivered to the client device 60, the destination list transmission module 51 reads the lists 52A, 52B and 52C corresponding to the client device 60 from the destination list storage module 52. The timing is, for example, when the delivery of the lists 52A, 52B and 52C has been requested by the client device 60.

In this case, for example, using a Get command based on HTTP, the client device 60 (destination list reception module 610) requests the server device 50 (destination list transmission module 51) to transmit the lists 52A, 52B and 52C. To be more specific, the destination list reception module 610 transmits an access request (delivery request), such as “http://Server\Web\MailList\{client name}”, to the server device 50 (destination list transmission module 51), thereby requesting the server device 50 to deliver the lists 52A, 52B and 52C. The client name included in the delivery request is, for example, the computer name which is given to the client device 60.

The timing when the lists 52A, 52B and 52C are delivered to the client device 60 may be, for instance, when the client device 60 has been activated, when the lists 52A, 52B and 52C have been updated, or when a predetermined period (e.g. one hour) has passed since the lists 52A, 52B and 52C were previously delivered.

For example, upon receiving the delivery request by the client device 60, the destination list transmission module 51 detects the group to which the target client device 60 belongs by using the client name included in the delivery request and the group information 53A. The target client device 60 is also referred to as “delivery-target client device 60”. Then, using the delivery list information 54A, the destination list transmission module 51 detects the lists 52A, 52B and 52C which are to be delivered to the detected group. Subsequently, the destination list transmission module 51 reads the lists 52A, 52B and 52C, which are to be delivered to the detected group, from the destination list storage module 52. The destination list transmission module 51 transmits the read lists 52A, 52B and 52C to the client device 60 (destination list reception module 610).

In the meantime, the destination list transmission module 51 may inquire of the mode determination module 56 about the operation mode which is suitable for the delivery-target client device 60 (or the group to which the client device 60 belongs). In this case, the mode determination module 56 determines in which operation mode among the monitoring mode, alert mode and block mode (the block mode by white list or the block mode by black list) the delivery-target client device 60 is to be operated. The mode determination module 56 determines the operation mode of the client device 60, for example, in accordance with the condition of use of e-mails (e.g. the number of times of transmission, the frequency of transmission, and the time of use) in the client device 60. The mode determination module 56 outputs the mode information indicative of the determined operation mode to the destination list transmission module 51.

The destination list transmission module 51 selects the list which is associated with the operation mode determined by the mode determination module 56 from among the lists 52A, 52B and 52C to be delivered, which have been detected by using the group information 53A and delivery list information 54A. For example, when the operation mode of the client device 60 has been determined to be the “Alert mode” by the mode determination module 56, the destination list transmission module 51 selects the destination address list 52A including the mode information indicative of “Alert mode”. For example, when the operation mode of the client device 60 has been determined to be the “Block mode by white list” by the mode determination module 56, the destination list transmission module 51 selects the white list 52B including the mode information indicative of “Block mode by white list”. Besides, for example, when the operation mode of the client device 60 has been determined to be the “Block mode by black list” by the mode determination module 56, the destination list transmission module 51 selects the black list 52C including the mode information indicative of “Block mode by black list”. Then, the destination list transmission module 51 reads a selected one of the lists 52A, 52B and 52C from the destination list storage module 52. The destination list transmission module 51 transmits the read list 52A, 52B, 52C to the client device 60 (destination list reception module 610).

The destination list reception module 610 of the client device 60 receives the list 52A, 53B, 53C which has been transmitted by the destination list transmission module 51. The destination list reception module 610 outputs the received list 52A, 52B, 52C to the destination list edit module 609. Using the list 52A, 52B, 52C which has been output by the destination list reception module 610, the destination list edit module 609 updates the destination address list 61A, white list 61B and black list 61C (hereinafter also referred to as “lists 61A, 61B and 61C”) which are stored in the destination list storage module 61. The destination list edit module 609 overwrites the destination address list 61A by using the destination address list 52A. The destination list edit module 609 overwrites the white list 61B by using the white list 52B. In addition, the destination list edit module 609 overwrites the black list 61C by using the black list 52C.

Next, referring to FIG. 10, a description is given of a setup screen (edit screen) 44 which is used in the creation of the list 52A, 52B, 52C by the list creation module 55. The setup screen 44 includes, for example, an operation mode select button 441, a target mail select button 442, a non-target domain input area 443, a monitoring-target select button 444, an alert keyword input area 445, a destination address input area 448, a permitted destination address input area 446, and a blocked destination address input area 447.

The operation mode select button 441 is a button for selecting an operation mode. Using the operation mode select button 441, the user selects the operation mode in which the client device 60 is operated, from among “Monitoring mode”, “Alert mode”, and “Block mode” (or “Block mode by white list” or “Block mode by black list”).

The target mail select button 442 is a button for selecting an e-mail which is a target of transmission control by the client device 60. Using the target mail select button 442, the user (system administrator) selects either “All mails” or “Mails other than registered domain”. In the meantime, when an e-mail is transmitted to an e-mail address having the same domain name as a sender-side e-main address, such this e-mail may be excluded from the target of transmission control.

The non-target domain input area 443 is an area for inputting a domain name (domain address) of an e-mail, the transmission of which is not controlled by the client device 60, when the “Mails other than registered domain” has been selected by using the target mail select button 442. Accordingly, the non-target domain input area 443 is made enabled only when the “Mails other than registered domain” has been selected by using the target mail select button 442. The user inputs to the non-target domain input area 443, for example, a domain name, the transmission of an e-mail to which needs not be controlled, such as a domain name used in a company or a domain name of an affiliated company (e.g. a domain name with little influence of information leak even if an e-mail is erroneously transmitted to this domain name).

The monitoring-target select button 444 is a button for selecting data, which is a target of monitoring based on a keyword (alert keyword), from among pieces of information included in an e-mail that is to be transmitted. Using the monitoring-target select button 444, the user selects one of “Mail header, text and attachment file”, “Mail header and text” and “Mail header”.

The alert keyword input area 445 is an area for inputting a keyword which is to be detected from the monitoring-target that has been selected by using the above-described monitoring-target select button 444. The user inputs, for example, a keyword “confidential” to the alert keyword input area 445.

The destination address input area 448 is an area for editing the destination address list 52A which is used when the operation mode is set to be the alert mode or the monitoring mode. The user can add, edit or delete an e-mail address which is included in the destination address list 52A using the destination address input area 448.

The permitted destination address input area 446 is an area for editing the white list 52B which is used when the operation mode is set to be the block mode (block mode by white list). The user can add, edit or delete an e-mail address which is included in the white list 52B using the permitted destination address input area 446.

The blocked destination address input area 447 is an area for editing the black list 52C which is used when the operation mode is set to be the block mode (block mode by black list). The user can add, edit or delete an e-mail address which is included in the black list 52C using the blocked destination address input area 447.

In the destination address input area 448, permitted destination address input area 446 and blocked destination address input area 447, e-mail addresses which are described by using a regular expression may be input. For example, an address “*@bbb.com” represents e-mail addresses including, for instance, “aaa@bbb.com” or “ccc@bbb.com”, since symbol “*” represents an arbitrary character string. Thus, the lists 52A, 52B and 52C and lists 61A, 61B and 61C may include e-mail addresses which are described by using a regular expression.

By using the above-described setup screen 44, the system administrator can input the operation mode in which the client device 60 is operated, or create (edit) the list 52A, 52B, 52C. Additional information including the information indicative of the targeted mail, the information indicative of the non-targeted domain, the information indicative of the alert keyword and the information indicative of the monitoring target based on the alert keyword, which has been input by using the setup screen 44, may be contained in the list 52A, 52B, 52C. In this case, the client device 60 can control the transmission of e-mails by using such additional information.

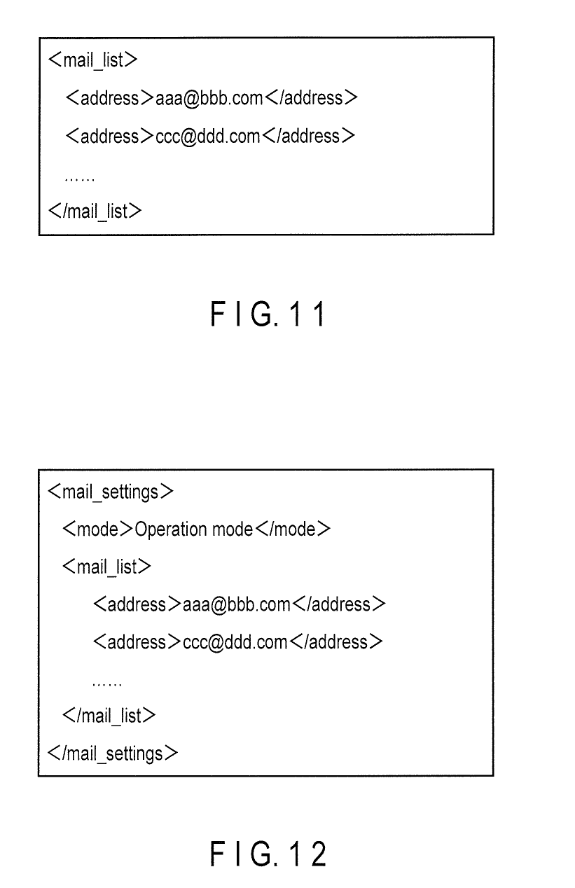

Next, FIG. 11 shows an example of the description of the list 52A, 52B, 52C, which is transmitted to the client device 60 by the destination list transmission module 51. The list 52A, 52B, 52C is described, for example, based on a markup language such as XML. The example shown in FIG. 11 describes that an e-mail address (e.g. “aaa@bbb.com”) is included in a list. The e-mail address is indicated by using an <address> tag. The list is indicated by using a <mail_list> tag.

FIG. 12 shows another example of the description of the list 52A, 52B, 52C, which is delivered. In the example shown in FIG. 12, an e-mail address included in the list is described by using a <mail_list> tag and an <address> tag, and mode information is described by using a <mode> tag. The mode information is indicative of the operation mode of the client device 60 (i.e. the operation mode in which this list of e-mail addresses is used). In addition, the list of e-mails, which is indicated by the <mail_list> tag, and the mode information, which is indicated by the <mode> tag, are described as mail setup information by using a <mail_settings> tag. The operation mode that is described is, for example, one of the monitoring mode, alert mode and block mode.

When the list 52A, 52B, 52C including the mode information as shown in FIG. 12 has been delivered, the destination list reception module 610 outputs the list of e-mail addresses in the delivered list 52A, 52B, 52C to the destination list edit module 609. In addition, the destination list reception module 610 outputs the mode information in the delivered list 52A, 52B, 52C to the mode switching module 603.

The destination list edit module 609 updates the list 61A, 61B, 61C stored in the destination list storage module 61, by using the list of e-mail addresses output by the destination list reception module 610. In addition, the mode switching module 603 switches the operation mode of the client device 60 to the designated operation mode, based on the mode information output by destination list reception module 610. Specifically, the mode switching module 603 sets the operation mode of the client device 60 to be any one of the monitoring mode, the alert mode, the block mode by white list, and the block mode by black list, based on the mode information.

By the above-described structure, in the communication control system 5, the destination list 52A, 52B, 52C is delivered from the server device 50 to the client device 60. The destination list 52A, 52B, 52C is a list for executing a predetermined process on the e-mail, which is transmitted by the client device 60. The destination list 52A, 52B, 52C includes, for example, the mode information for designating the operation mode of the client device 60, and the list of e-mail addresses.

Next, a description is given of the structure with which the client device 60 processes the e-mail, the transmission of which has been instructed, in each of the operation modes, i.e. the monitoring mode, alert mode and block mode.

To begin with, the transmission operation detection module 601 detects an operation of instructing the transmission of an e-mail. The operation of instructing the transmission of an e-mail is, for example, an operation which is input by the user. To be more specific, the user, for example, creates an e-mail by using a mailer program, or the like. In response to the pressing of a button for transmitting the created e-mail, the transmission operation detection module 601 detects an operation of instructing the transmission of the e-mail. The transmission operation detection module 601 notifies the destination extraction module 602 that the operation of instructing the transmission of the e-mail has been detected.

In response to the notification by the transmission operation detection module 601, the destination extraction module 602 extracts a destination e-mail address from e-mail data 63, the transmission of which has been instructed (i.e. e-mail data before transmission). To be more specific, the destination extraction module 602 extracts the e-mail address, which is set at “TO”, “CC” and “BCC”, from the e-mail data 63. Then, the transmission operation detection module 601 outputs the extracted e-mail address to the destination determination module 604.

The destination determination module 604 determines the e-mail address, which has been output by the destination extraction module 602, in accordance with the operation mode which has been set by the mode switching module 603 (i.e. the operation mode designated by the server device 50). Next, a description will be successively given of cases in which the operation mode has been set to be the monitoring mode, the alert mode, the block mode by white list and the block mode by black list by the mode switching module 603.

To begin with, a description is given of the case in which the operation mode has been set to be the monitoring mode by the mode switching module 603. In the monitoring mode, a destination of an e-mail is added to the destination address list 61A by monitoring the destination of the e-mail if the transmission of the e-mail has been instructed.

The destination determination module 604 determines whether the e-mail address that is to be processed, among the e-mail addresses which have been extracted by the destination extraction module 602, is included in the destination address list 61A. When the e-mail address, which is to be processed, is not included in the destination address list 61A, the destination determination module 604 outputs this e-mail address to the destination adding module 606. The destination adding module 606 adds the e-mail address, which has been output by the destination determination module 604, to the destination address list 61A.

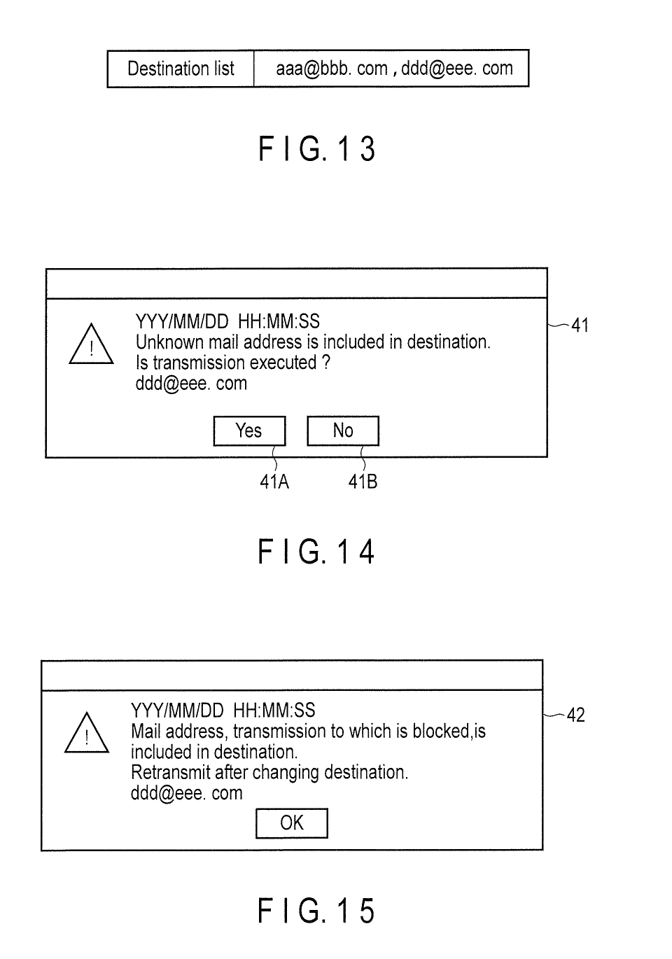

For example, the case is assumed in which the destination addresses of an e-mail, the transmission of which has been instructed (i.e. an e-mail before transmission), are “aaa@bbb.com” and “ddd@eee.com”, as shown in FIG. 13, and the destination address list 61A includes addresses “aaa@bbb.com” and “bbb@ccc.com”, as shown in FIG. 5.

The destination determination module 604 detects that the address “aaa@bbb.com” is included in the destination address list 61A, but the address “ddd@eee.com” is not included in the destination address list 61A. The destination determination module 604 outputs the address “ddd@eee.com” to the destination adding module 606. Then, the destination adding module 606 adds the address “ddd@eee.com” to the destination address list 61A.

When the destination determination module 604 has completed the determination as to all e-mail addresses which have been extracted by the destination extraction module 602, the destination determination module 604 requests the mail transmission module 607 to transmit the e-mail. In response to the request by the destination determination module 604, the mail transmission module 607 transmits the e-mail to the e-mail addresses extracted by the destination extraction module 602.

By the above-described structure, the transmission of the e-mail is controlled in the monitoring mode. In the monitoring mode, when the transmission of an e-mail has been instructed, the destination address of the e-mail is added to the destination address list 61A. Specifically, each time an e-mail is transmitted, the destination e-mail address of the e-mail is added to the destination address list 61A. For example, if no e-mail address is included in the destination address list 61A (for example, at the time of the initial state), the client device 60 may be set in the monitoring mode for only a predetermined period, and thereby the destination address list 61A may be constructed. Besides, in the monitoring process, after the e-mail is transmitted, the destination e-mail address of the e-mail may be added to the destination address list 61A.

Next, a description is given of the case in which the operation mode has been set to be the alert mode by the mode switching module 603. In the alert mode, if a transmission of an e-mail has been instructed and the e-mail includes a destination address which is not described in the destination address list 61A, an alert is issued to the user.

To begin with, the destination determination module 604 determines whether the e-mail address of the e-mail addresses which have been extracted by the destination extraction module 602, is included in the destination address list 61A. If the e-mail address is not included in the destination address list 61A, the destination determination module 604 outputs this e-mail address to the destination adding module 606. The destination adding module 606 adds the e-mail address to a first address list. The first address list is a work area for storing an e-mail address which is not included in the destination address list 61A. When an operation for transmitting an e-mail has been detected, the first address list is set to be an empty list including no e-mail address.

When the destination determination module 604 has completed the determination as to all e-mail addresses which have been extracted by the destination extraction module 602, the destination determination module 604 determines whether the first address list is empty or not. If the first address list is empty, the destination determination module 604 requests the mail transmission module 607 to transmit the e-mail. In response to the request by the destination determination module 604, the mail transmission module 607 transmits the e-mail to the e-mail addresses extracted by the destination extraction module 602.

If the first address list is not empty, the destination determination module 604 requests the display control module 605 to display a select screen. In response to the request by the destination determination module 604, the display control module 605 displays the select screen. The select screen displays, for example, a button for executing selection as to whether or not to continue the transmission of the e-mail.

For example, the case is assumed in which the destination addresses of the e-mail, the transmission of which has been instructed (i.e. the e-mail before transmission), are “aaa@bbb.com” and “ddd@eee.com”, as shown in FIG. 13, and the destination address list 61A includes addresses “aaa@bbb.com” and “bbb@ccc.com”, as shown in FIG. 5. In this case, the destination determination module 604 detects that the address “aaa@bbb.com” is included in the destination address list 61A, but the address “ddd@eee.com” is not included in the destination address list 61A. Thus, the destination determination module 604 outputs the address “ddd@eee.com” to the destination adding module 606. The destination adding module 606 adds the address “ddd@eee.com” to the first address list. Then, since the first address list is not empty, the destination determination module 604 requests the display control module 605 to display a select screen 41 as shown in FIG. 14.

FIG. 14 shows an example of the select screen 41 displayed by the display control module 605. The select screen 41 includes an alert message indicating that an e-mail is to be sent to the address (unknown e-mail address) “ddd@eee.com” which is not included in the destination address list 61A. In addition, the select screen 41 includes a button 41A for continuing the transmission of the e-mail, and a button 41B for canceling the transmission of the e-mail. By selecting either the button 41A or button 41B, the user selects the continuation or cancellation of the transmission of the e-mail.

In accordance with the input using the select screen 41, the display control module 605 determines whether to continue the transmission of the e-mail. If the user has pressed the button 41A for continuing the transmission of the e-mail, the display control module 605 outputs the first address list to the destination adding module 606. The destination adding module 606 adds the e-mail address included in the first address list to the destination address list 61A. Then, the destination determination module 604 requests the mail transmission module 607 to transmit the e-mail. The mail transmission module 607 transmits the e-mail to the e-mail address which has been extracted by the destination extraction module 602.

On the other hand, if the user has pressed the button 41B for canceling the transmission of the e-mail, the display control module 605 requests the transmission cancel module 608 to cancel the transmission of the e-mail. In response to the request by the display control module 605, the transmission cancel module 608 cancels the transmission of the e-mail. Specifically, the transmission cancel module 608 cancels the operation of instructing the transmission of the e-mail. In this case, the display control module 605 may return to the edit screen (mailer program) for editing the e-mail.

By the above-described structure, the transmission of the e-mail is controlled in the alert mode. In the alert mode, if a transmission of an e-mail has been instructed and the destination address of the e-mail is not included in the destination address list 61A, the select screen 41 is displayed. By the display of the select screen 41, the user can confirm that the e-mail is about to be transmitted to an unknown e-mail address, and can execute selection as to whether the transmission of the e-mail is to be continued or canceled. In addition, when the selection has been executed to continue the transmission of the e-mail, the destination address of the e-mail is added to the destination address list 61A. Thereby, when the transmission of an e-mail to the same destination address is instructed hereafter, an alert by the select screen 41 is not issued, and the load on the user's operation can be reduced. Meanwhile, in the alert mode, the select screen 41 may be displayed after an e-mail has been transmitted to only the e-mail addresses included in the destination address list 61A.

Next, a description is given of the case in which the operation mode has been set to be the block mode by white list by the mode switching module 603. In the block mode by white list, an e-mail is transmitted to only the destination address that is described in the white list 61B, among destination addresses of the e-mail if the transmission of the e-mail has been instructed. In other words, in the block mode by white list, the e-mail is not transmitted to the destination address that is not described in the white list 61B, among destination addresses of the e-mail. In short, the white list 61B is a permitted destination address list indicative of addresses to which the transmission of e-mails is permitted.

In the block mode by the white list 61B, the destination determination module 604 first determines whether an e-mail address, which has been extracted by the destination extraction module 602, is included in the white list 61B. If all e-mail addresses which have been extracted by the destination extraction module 602 are included in the white list 61B, the destination determination module 604 requests the mail transmission module 607 to transmit the e-mail. Then, the mail transmission module 607 transmits the e-mail to all e-mail addresses extracted by the destination extraction module 602.

If an e-mail address, which is not included in the white list 61B, is present among the e-mail addresses extracted by the destination extraction module 602, the destination determination module 604 requests the display control module 605 to display a confirmation screen. Then, the display control module 605 displays the confirmation screen in response to the request by the destination determination module 604.

For example, the case is assumed in which the destination addresses of an e-mail, the transmission of which has been instructed (i.e. an e-mail before transmission), are “aaa@bbb.com” and “ddd@eee.com”, as shown in FIG. 13, and the white list 61B includes addresses “aaa@bbb.com” and “bbb@ccc.com”, as shown in FIG. 6. In this case, the destination determination module 604 detects that the address “aaa@bbb.com” is included in the white list 61B, but the address “ddd@eee.com” is not included in the white list 61B. Thus, the destination determination module 604 requests the display control module 605 to display the confirmation screen. The display control module 605 displays the confirmation screen 42 as shown in FIG. 15.

FIG. 15 shows an example of the confirmation screen 42 displayed by the display control module 605. The confirmation screen 42 includes a message notifying that the e-mail is not transmitted since the destination addresses of the e-mail include the address “ddd@eee.com” which is not included in the white list 61B.

In addition, the display control module 605 requests the transmission cancel module 608 to cancel the transmission of the e-mail. In response to the request by the display control module 605, the transmission cancel module 608 cancels the transmission of the e-mail. Specifically, the transmission cancel module 608 cancels the operation of instructing the transmission of the e-mail. In this case, the display control module 605 may return to the edit screen for editing the e-mail.

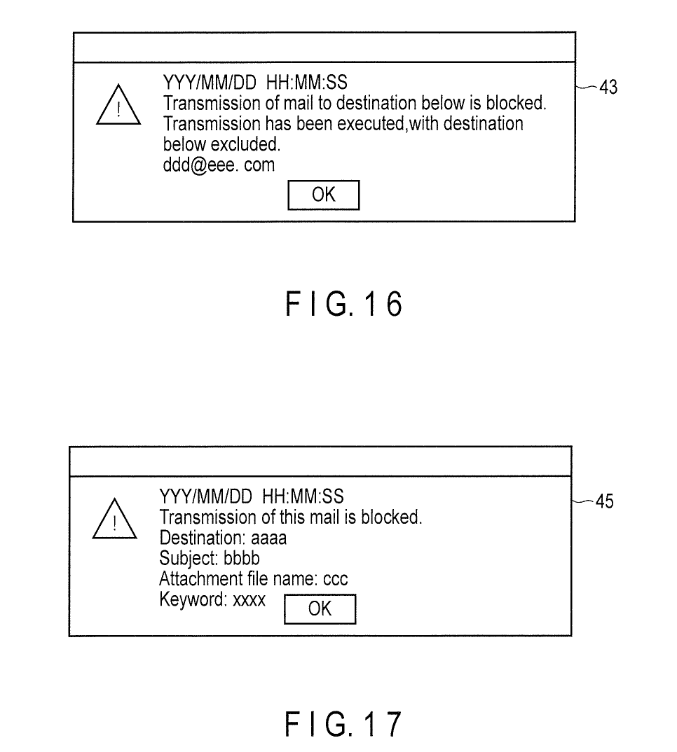

In the block mode by white list, the destination determination module 604 may execute such control as to transmit the e-mail to only the address “aaa@bbb.com” which is included in the white list 61B, and not to transmit the e-mail to the address “ddd@eee.com” which is not included in the white list 61B. In this case, as shown in FIG. 16, the display control module 605 displays a confirmation screen 43 including a message notifying that the e-mail has been transmitted to the address excluding the address “ddd@eee.com”.

Next, a description is given of the case in which the operation mode has been set to be the block mode by the black list 61C by the mode switching module 603. In the block mode by black list, an e-mail is not transmitted to the destination address that is described in the black list 61C, among destination addresses of the e-mail if the transmission of the e-mail has been instructed. In other words, in the block mode by the black list 61C, the e-mail is transmitted to only the destination address that is not described in the black list 61C, among destination addresses of the e-mail. In short, the black list 61C is a blocked destination address list indicative of addresses to which the transmission of e-mails is blocked.

In the block mode by the black list 61C, the destination determination module 604 first determines whether an e-mail address, which has been extracted by the destination extraction module 602, is included in the black list 61C. If none of the e-mail addresses is included in the black list 61C, the destination determination module 604 requests the mail transmission module 607 to transmit the e-mail. Then, the mail transmission module 607 transmits the e-mail to all e-mail addresses extracted by the destination extraction module 602.

If an e-mail address, which is included in the black list 61C, is present among the e-mail addresses extracted by the destination extraction module 602, the destination determination module 604 requests the display control module 605 to display a confirmation screen. Then, the display control module 605 displays the confirmation screen in response to the request by the destination determination module 604.

For example, the case is assumed in which the destination addresses of an e-mail, the transmission of which has been instructed (i.e. an e-mail before transmission), are “aaa@bbb.com” and “ddd@eee.com”, as shown in FIG. 13, and the black list 61C includes addresses “bbb@ccc.com” and “ddd@eee.com”, as shown in FIG. 7. In this case, the destination determination module 604 detects that the address “aaa@bbb.com” is not included in the black list 61C, but the address “ddd@eee.com” is included in the black list 61C. Thus, the destination determination module 604 requests the display control module 605 to display the confirmation screen. The display control module 605 displays the confirmation screen 42 as shown in FIG. 15. The confirmation screen 42 includes a message notifying that the e-mail is not transmitted since the destination addresses of the e-mail include the address “ddd@eee.com” which is included in the black list 61C.

In addition, the display control module 605 requests the transmission cancel module 608 to cancel the transmission of the e-mail. In response to the request by the display control module 605, the transmission cancel module 608 cancels the transmission of the e-mail. Specifically, the transmission cancel module 608 cancels the operation of instructing the transmission of the e-mail. In this case, the display control module 605 may return to the edit screen for editing the e-mail.

In the block mode by black list, the destination determination module 604 may execute such control as to transmit the e-mail to only the address “aaa@bbb.com” which is not included in the black list 61C, and not to transmit the e-mail to the address “ddd@eee.com” which is included in the black list 61C. In this case, as shown in FIG. 16, the display control module 605 displays the confirmation screen 43 including a message notifying that the e-mail has been transmitted to the address excluding the address “ddd@eee.com”.

By the above-described structure, the transmission of e-mails is controlled in the block mode. In the block mode, if the destination address of an e-mail is not included in the white list 61B, or if the destination address of an e-mail is included in the black list 61C, the confirmation screen 42, 43 is displayed. By the display of the confirmation screen 42, 43, the user can confirm that the e-mail has not been transmitted to the e-mail address which is not included in the white list 61B or to the e-mail address which is included in the black list 61C.

In the meantime, the destination list edit module 609 may add, edit or delete e-mail addresses in the destination address list 61A, white list 61B and black list 61C. By the edit of the destination address list 61A by the destination list edit module 609, it is possible to prevent, for example, at the time of the operation in the alert mode, such a situation from occurring that the destination address of an erroneously transmitted e-mail is left in the destination address list 61A. For example, if an e-mail has transmitted by pressing the button 41A for continuing the transmission erroneously, the destination address of the e-mail is left from the destination address list 61A by the destination list edit module 609. For example, in order to edit the list 61A, 61B, 61C, the destination list edit module 609 can display the setup screen (edit screen) 44 as shown in FIG. 10. In accordance with the input by the user with use of the setup screen 44, the e-mail address included in the list 61A, 61B, 61C is edited (added, deleted). In addition, the destination list edit module 609 can input e-mail addresses which serve as default values of the list 61A, 61B, 61C.

In the meantime, when an e-mail is a return mail to a received e-mail, the destination determination module 604 may exclude this return mail from the targets of transmission control. When a return mail is to be transmitted, the destination e-mail address is not input, and it is thus assumed that the return mail is not transmitted to a wrong destination. Hence, when an e-mail is a return mail, the destination determination module 604 does not execute determination using the destination address list 61A, etc. (i.e. the destination determination module 604 excludes the return mail from the targets of transmission control in the alert mode and block mode), and requests the mail transmission module 607 to transmit the return mail. For example, when the subject of an e-mail begins with “RE:”, the destination determination module 604 determines that this e-mail is a return mail, and excludes this e-mail from targets of transmission control. In the meantime, selection as to whether to set the return mail to be the target of transmission control may be executed in the server device 50 (e.g. with use of the setup screen 44).

In addition, when the domain name of the destination e-mail address of an e-mail is identical to the domain name of the sender e-mail address of the e-mail, this e-mail may be excluded from the targets of transmission control. When the domain name of the destination e-mail address is identical to the domain name of the sender e-mail address, it is assumed that even if the e-mail is wrongly transmitted, the influence of information leak is limited. Thus, when the domain name of the destination e-mail address is identical to the domain name of the sender e-mail address, the destination determination module 604 may not execute determination using the list 61A, 61B, 61C (i.e. the destination determination module 604 may exclude this e-mail from the targets of transmission control in the alert mode and block mode), and may request the mail transmission module 607 to transmit this e-mail. In the meantime, selection as to whether to set the e-mail, which is to be transmitted to the e-mail address having the same domain name as the domain name of the sending side, to be the target of transmission control may be executed in the server device 50 (e.g. with use of the setup screen 44).

The destination extraction module 602 may extract a keyword (e.g. “confidential”), which is set to be an alert keyword, from the target of monitoring (e.g. “Mail header and text”) in the e-mail data 63. The destination extraction module 602 outputs the extracted keyword to the destination determination module 604. When the alert keyword has been extracted, the destination determination module 604 requests the display control module 605 to display a confirmation screen. The display control module 605 display, for example, a confirmation screen as shown in FIG. 17. The confirmation screen 45 includes, for example, a message indicating that the transmission of an e-mail is canceled (the alert keyword is included in the e-mail). In addition, the display control module 605 requests the transmission cancel module 608 to cancel the transmission of the e-mail. Then, the transmission cancel module 608 cancels the transmission of the e-mail. As described above, the alert keyword is selected, for example, in the server device 50 (e.g. with use of the alert keyword input area 445 of the setup screen 44).

The mail transmission module 607 may instruct the mailer program, etc. to transmit an e-mail. Specifically, the mail transmission module 607 does not perform the transmission itself of an e-mail, but outputs a signal requesting the transmission of the e-mail to the mailer program, thereby causing the mailer program to transmit the e-mail. In other words, during the time period from when the user instructs the transmission of an e-mail to when the mailer program actually transmits the e-mail, the process for controlling the transmission of the e-mail in the monitoring mode, alert mode or block mode is performed.

In the meantime, in the alert mode, an alert based on the destination address of an e-mail may be issued by using the white list 61B or black list 61C. In addition, in the alert mode, the block mode by white list and the block mode by black list, it is possible to execute the process in the monitoring mode for adding the destination address of the transmitted e-mail to the destination address list 61A. Furthermore, the client device 60 is operable in a block mode using both the white list 61B and black list 61C. Specifically, the client device 60 controls the transmission of an e-mail by using both the white list 61B and black list 61C.

In the structure of the present embodiment, since the transmission of e-mails is controlled in the client device 60 which is used by the user for the transmission/reception of e-mails, the embodiment can be realized by, for example, adding the above-described structure to the mailer program. This can be realized at a lower cost than in the case of altering the structure of the server device, such as a mail server, so as to control e-mails which are transmitted from the client device 60, and the load on the server device does not increase.

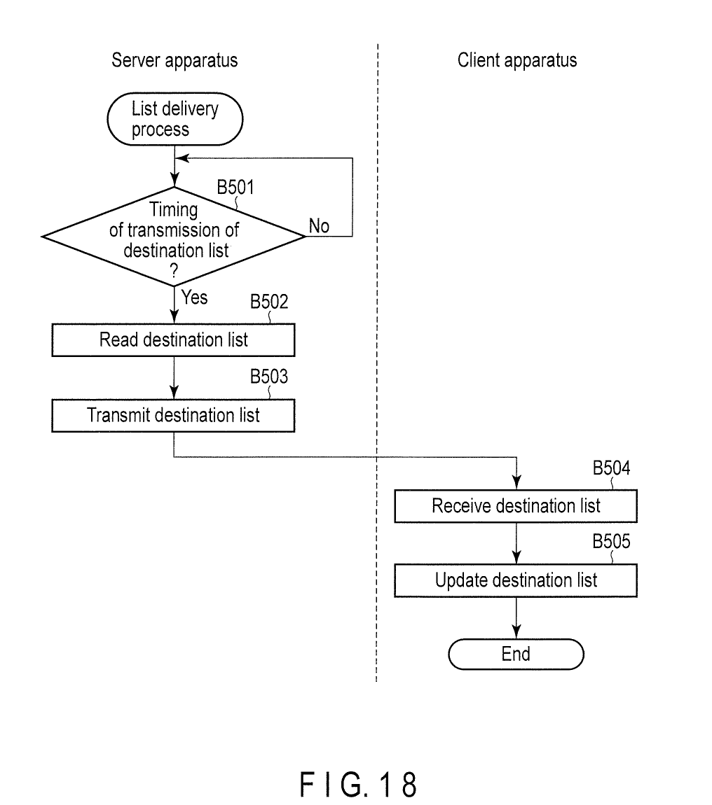

Next, referring to a flowchart of FIG. 18, a description is given of an example of the procedure of a list delivery process which is executed by the communication control system 5.

The destination list transmission module 51, which is provided in the server device 50, determines whether there has come a timing at which the list 52A, 52B, 52C is delivered (block B501). When the timing at which the list 52A, 52B, 52C is transmitted has not yet come (NO in block B501), the process returns to block B501.

When the timing at which the list 52A, 52B, 52C is transmitted has come (YES in block B501), the destination list transmission module 51 reads, from the destination list storage module 52, the list 52A, 52B, 52C corresponding to the client device 60 (block B502). Then, the destination list transmission module 51 transmits the read list 52A, 52B, 52C to the destination list reception module 610 that is provided in the client device 60 (block B503).

The destination list reception module 610 receives the list 52A, 52B, 52C, which has been transmitted by the destination list transmission module 51 (block B504). The destination list reception module 610 outputs the received list 52A, 52B, 52C to the destination list edit module 609. Using the list 52A, 52B, 52C output by the destination list reception module 610, the destination list edit module 609 updates the list 61A, 61B, 61C stored in the destination list storage module 61 (block B505).

By the above-described process, the list 61A, 61B, 61C, which is stored in the client device 60 (destination list storage module 61), can be updated by using the list 52A, 52B, 52C which is stored in the server device 50. The list that is updated may be one of the lists 61A, 61B and 61C. In this case, the destination list transmission module 51 reads the list corresponding to this one list, and transmits it to the destination list reception module 610.

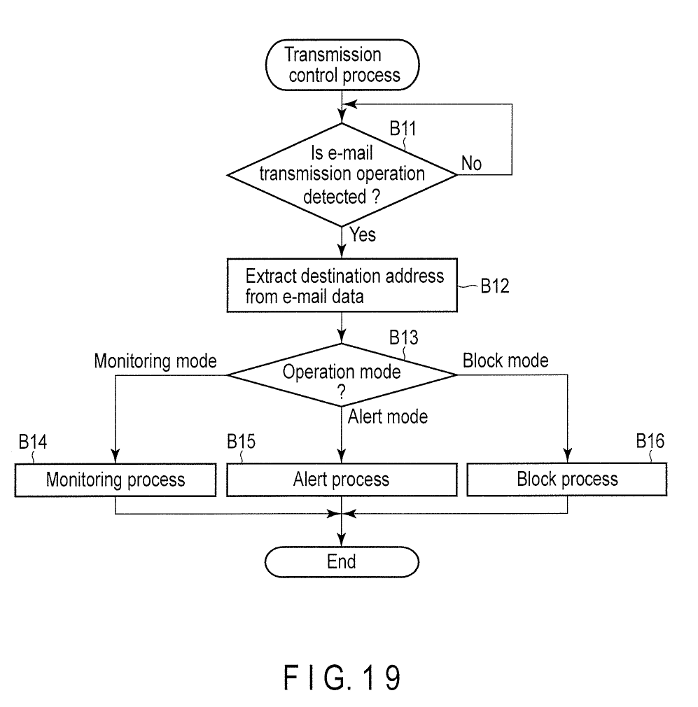

Next, referring to a flowchart of FIG. 19, a description is given of an example of the procedure of a transmission control process which is executed by the communication control system 5.

To start with, the transmission operation detection module 601 determines whether an operation of instructing the transmission of an e-mail has been detected (block B11). If the operation of instructing the transmission of an e-mail has not been detected (NO in block B11), the transmission operation detection module 601 determines once again whether the operation of instructing the transmission of an e-mail has been detected by returning to block B11.

If the operation of instructing the transmission of an e-mail has been detected (YES in block B11), the destination extraction module 602 extracts a destination e-mail address from e-mail data that is a target of transmission (block B12). The destination extraction module 602 outputs the extracted e-mail address to the destination determination module 604.

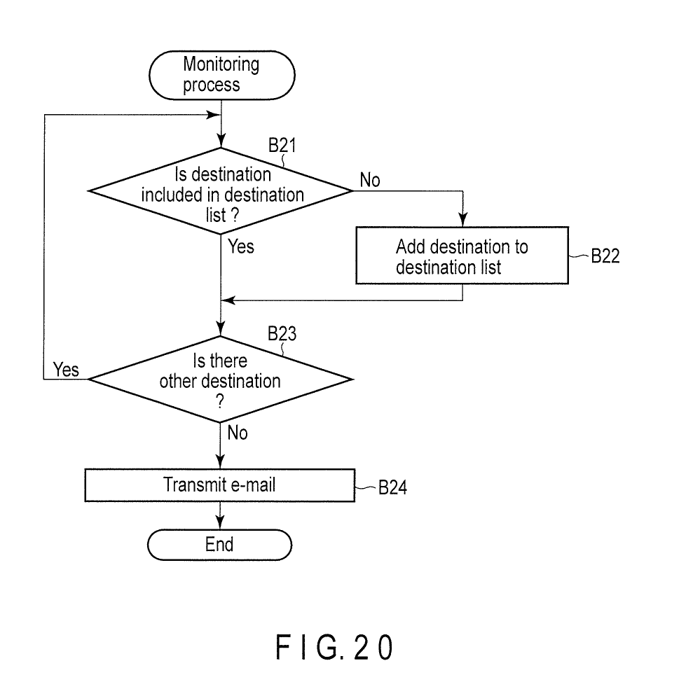

Then, the mode switching module 603 determines whether the operation mode is the monitoring mode, the alert mode or the block mode (block B13). If the operation mode is the monitoring mode (“Monitoring mode” in block B13), a monitoring process of monitoring the destination address of the e-mail is executed (block B14). The procedure of the monitoring process will be described later with reference to a flowchart of FIG. 20.

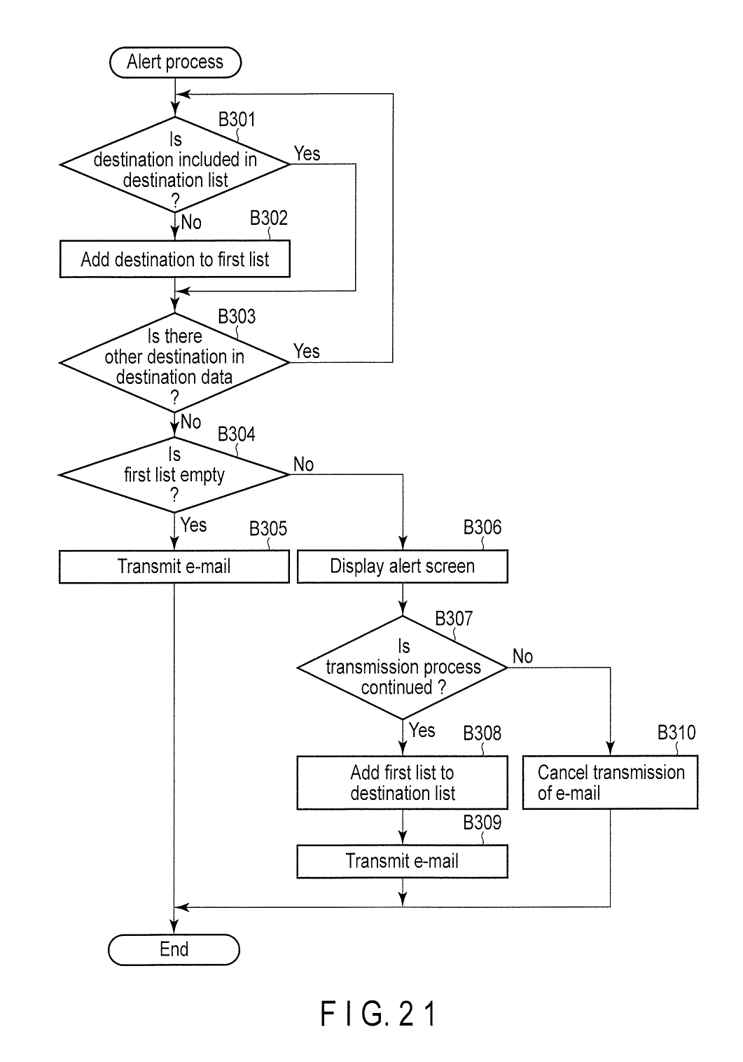

If the operation mode is the alert mode (“Alert mode” in block B13), an alert process based on the destination address of the e-mail and the destination address list 61A is executed (block B15). The procedure of the alert process will be described later with reference to a flowchart of FIG. 21.

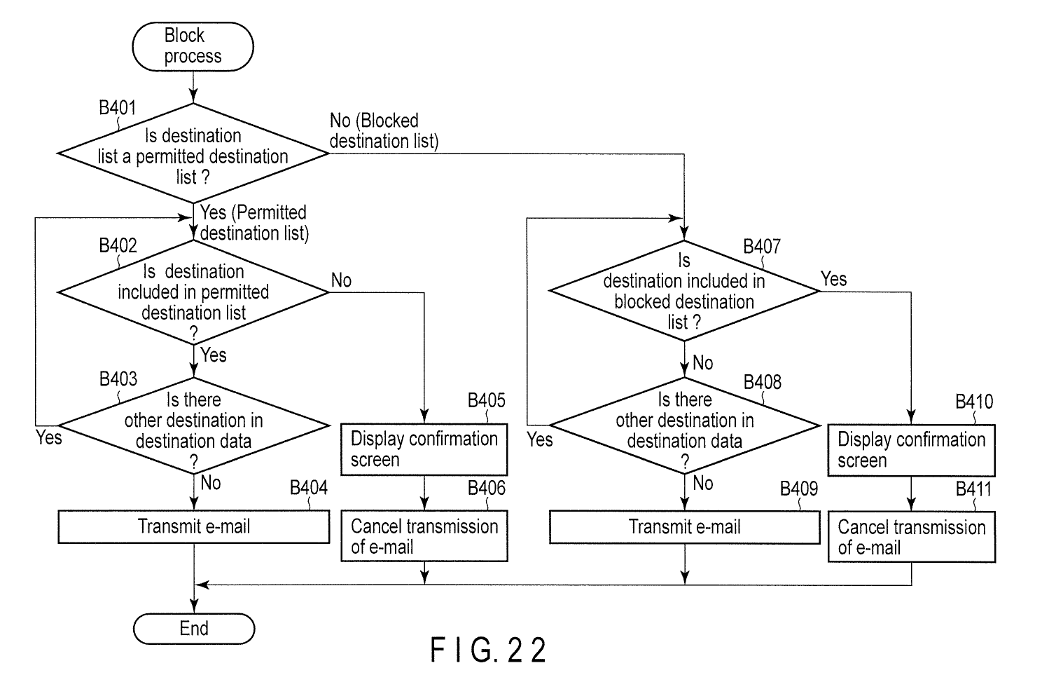

If the operation mode is the block mode (“Block mode” in block B13), a block process based on the destination address of the e-mail, the permitted destination list (white list) 61B and the blocked destination list (black list) 61C, is executed (block B16). The procedure of the block process will be described later with reference to a flowchart of FIG. 22.

Next, FIG. 20 is a flowchart illustrating an example of the procedure of the monitoring process corresponding to block B14 in FIG. 19. The case is now assumed in which a plurality of e-mail addresses have been extracted from an e-mail that is a target of transmission.

To begin with, the destination determination module 604 determines whether an e-mail address of the e-mail addresses (destination addresses) extracted by the destination extraction module 602 is included in the destination address list 61A (block B21). If the e-mail address is not included in the destination address list 61A (NO in block B21), the destination adding module 606 adds the e-mail address to the destination address list 61A (block B22).

After the e-mail address is added to the destination address list 61A in block B22, or if the e-mail address is included in the destination address list 61A (YES in block B21), the destination determination module 604 determines whether the e-mail addresses extracted by the destination extraction module 602 includes an e-mail address that is the next target of processing (block B23). If the e-mail addresses extracted by the destination extraction module 602 includes the e-mail address that is the next target of processing (YES in block B23), the process returns to block B21.

If the e-mail addresses extracted by the destination extraction module 602 does not include the e-mail address that is the next target of processing (NO in block B23), the mail transmission module 607 transmits the e-mail to the e-mail addresses that has been extracted by the destination extraction module 602 (block B24).

By the above-described process, the process in the monitoring mode can be executed. In the meantime, in this monitoring process, after the procedure of transmitting the e-mail in block B24 has been executed, the procedure of block B21 to block B23 may be executed.

FIG. 21 is a flowchart illustrating an example of the procedure of the alert process corresponding to block B15 in FIG. 19. The case is now assumed in which a plurality of e-mail addresses have been extracted from an e-mail that is a target of transmission.

To start with, the destination determination module 604 determines whether an e-mail address of the e-mail addresses (destination addresses) extracted by the destination extraction module 602 is included in the destination address list 61A (block B301). If the e-mail address is not included in the destination address list 61A (NO in block B301), the destination adding module 606 adds the e-mail address to a first address list (block B302). The first address list is an empty list including no e-mail address when the alert process is started (when the operation of instructing the transmission of an e-mail is newly detected).

After the e-mail address is added to the first address list in block B302, or if the e-mail address is included in the destination address list 61A (YES in block B301), the destination determination module 604 determines whether the e-mail addresses extracted by the destination extraction module 602 includes an e-mail address that is the next target of processing (block B303). If the e-mail addresses extracted by the destination extraction module 602 includes the e-mail address that is the next target of processing (YES in block B303), the process returns to block B301.

If the e-mail addresses extracted by the destination extraction module 602 does not include the e-mail address that is the next target of processing (NO in block B303), the destination determination module 604 determines whether the first address list is an empty list (block B304). If the first address list is an empty list (YES in block B304), the mail transmission module 607 transmits the e-mail to the e-mail addresses extracted by the destination extraction module 602 (block B305).

If the first address list is not an empty list (NO in block B304), the display control module 605 displays the select screen 41 (block B306). The select screen 41 displays, for example, the button for executing selection as to whether or not to continue the transmission of the e-mail.

Then, the display control module 605 determines whether the transmission of the e-mail is to be continued (block B307). If the transmission of the e-mail is continued (YES in block B307), the destination adding module 606 adds the e-mail address included in the first address list to the destination address list 61A (block B308). Then, the mail transmission module 607 transmits the e-mail to the e-mail addresses extracted by the destination extraction module 602 (block B309).

On the other hand, if the transmission of the e-mail is canceled (NO in block B307), the transmission cancel module 608 cancels the transmission of the e-mail (block B310). The transmission cancel module 608 cancels the operation of instructing the transmission of the e-mail.

FIG. 22 is a flowchart illustrating an example of the procedure of the block process corresponding to block B16 in FIG. 19. The case is now assumed in which a plurality of e-mail addresses have been extracted from an e-mail that is a target of transmission.

To start with, the destination determination module 604 determines whether the destination address list that is used in the block mode is the permitted destination address list (white list) 61B (block B401). If the destination address list that is used is the permitted destination address list 61B (YES in block B401), the destination determination module 604 determines whether an e-mail address of the e-mail addresses extracted by the destination extraction module 602 is included in the permitted destination address list 61B (block B402). If the e-mail address is included in the permitted destination address list 61B (YES in block B402), the destination determination module 604 determines whether the e-mail addresses extracted by the destination extraction module 602 includes an e-mail address that is the next target of processing (block B403). If the e-mail addresses extracted by the destination extraction module 602 includes the e-mail address that is the next target of processing (YES in block B403), the process returns to block B402. On the other hand, if the e-mail addresses extracted by the destination extraction module 602 does not includes the e-mail address that is the next target of processing (NO in block B403), the mail transmission module 607 transmits the e-mail to the e-mail addresses extracted by the destination extraction module 602 (block B404).

If the e-mail address is not included in the permitted destination address list 61B (NO in block B402), the display control module 605 displays the confirmation screen 42 (block B405). The confirmation screen 42 notifies, for example, that the e-mail address, which is not included in the permitted destination address list 61B, is set to be the destination. Then, the transmission cancel module 608 cancels the transmission of the e-mail (block B406). In the meantime, instead of the cancellation of the transmission of the e-mail, the mail transmission module 607 may transmit the e-mail to an e-mail address included in the permitted destination address list 61B, among the e-mail addresses extracted by the destination extraction module 602.

If the destination address list that is used is the blocked destination address list (black list) 61C (NO in block B401), the destination determination module 604 determines whether an e-mail address of the e-mail addresses extracted by the destination extraction module 602 is included in the blocked destination address list 61C (block B407). If the e-mail address is not included in the blocked destination address list 61C (NO in block B407), the destination determination module 604 determines whether the e-mail addresses extracted by the destination extraction module 602 includes an e-mail address that is the next target of processing (block B408). If the e-mail addresses extracted by the destination extraction module 602 includes the e-mail address that is the next target of processing (YES in block B408), the process returns to block B407. On the other hand, if the e-mail addresses extracted by the destination extraction module 602 does not include the e-mail address that is the next target of processing (NO in block B408), the mail transmission module 607 transmits the e-mail to the e-mail addresses extracted by the destination extraction module 602 (block B409).

If the e-mail address is included in the blocked destination address list 61C (YES in block B407), the display control module 605 displays the confirmation screen 42 (block B410). The confirmation screen 42 notifies, for example, that the e-mail address, which is included in the blocked destination address list 61C, is set to be the destination. Then, the transmission cancel module 608 cancels the transmission of the e-mail (block B411). In the meantime, instead of the cancellation of the transmission of the e-mail, the mail transmission module 607 may transmit the e-mail to an e-mail address which is not included in the blocked destination address list 61C, among the e-mail addresses extracted by the destination extraction module 602.

The confirmation screen 42 (see FIG. 15), which is displayed in block B405 or B410, may be the confirmation screen 43 shown in FIG. 16. In this case, the e-mail is transmitted to an e-mail address which is included in the permitted destination address list 61B or an e-mail address which is not included in the blocked destination address list 61C. Then, the confirmation screen 43 is displayed to indicate that the e-mail has not been transmitted to an e-mail address which is not included in the permitted destination address list 61B or an e-mail address which is included in the blocked destination address list 61C.

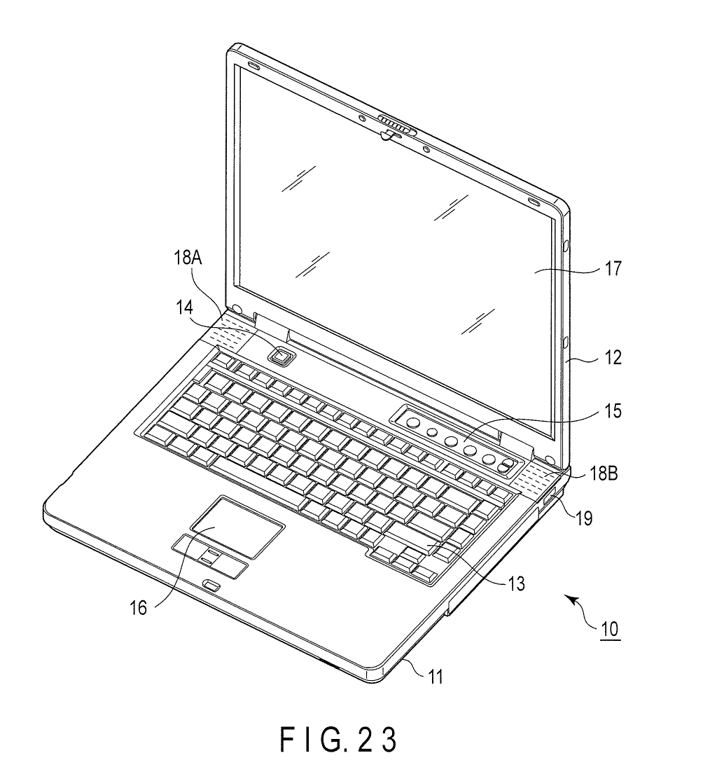

FIG. 23 is a perspective view showing the external appearance of an electronic apparatus according to a second embodiment. This electronic apparatus is realized, for example, as a notebook-type personal computer 10. Besides, the electronic apparatus may also be realized as various kinds of electronic apparatuses with communication functions, such as a mobile phone, a smartphone and a PDA. As shown in FIG. 23, the computer 10 includes a computer main body 11 and a display unit 12. A liquid crystal display (LCD) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered.

The computer main body 11 has a thin box-shaped housing. A keyboard 13, a power button 14 for powering on/off the computer 10, an input operation panel 15, a touch pad 16, and speakers 18A and 18B are disposed on the top surface of the housing of the computer main body 11. Various operation buttons are provided on the input operation panel 15.

The right side surface of the computer main body 11 is provided with a USB connector 19 for connection to a USB cable or a USB device of, e.g. the universal serial bus (USB) 2.0 standard.

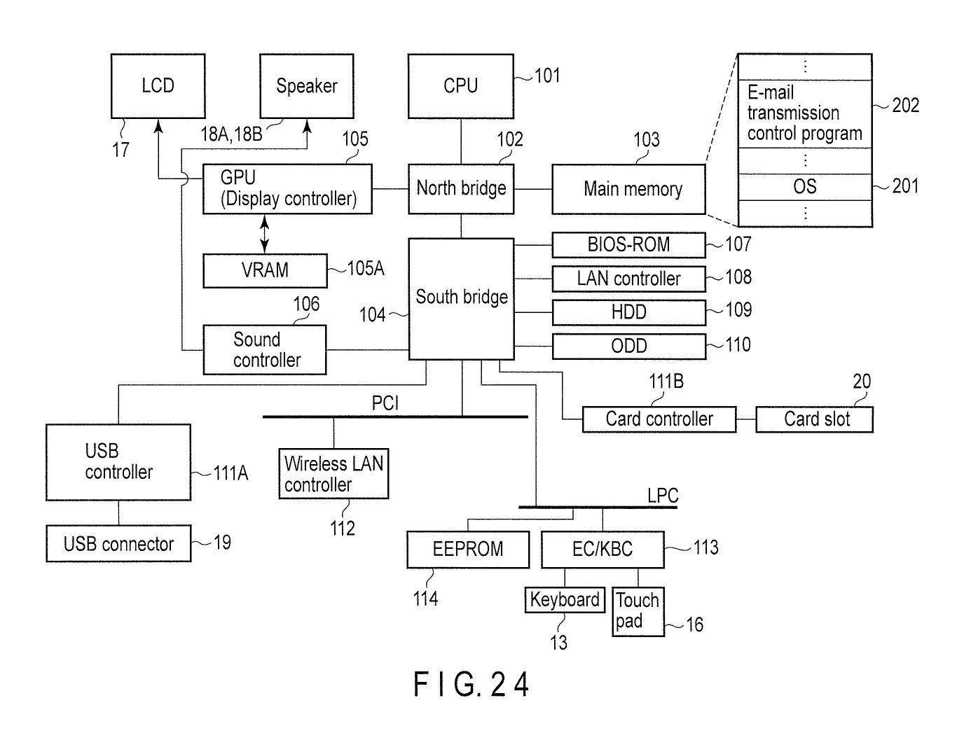

FIG. 24 shows the system configuration of the computer 10.

The computer 10, as shown in FIG. 24, includes a central processing unit (CPU) 101, a north bridge 102, a main memory 103, a south bridge 104, a graphics processing unit (GPU) 105, a video random access memory (VRAM) 105A, a sound controller 106, a basic input/output system-read only memory (BIOS-ROM) 107, a local area network (LAN) controller 108, a hard disk drive (HDD) 109, an optical disc drive (ODD) 110, a USB controller 111A, a card controller 111B, a wireless LAN controller 112, an embedded controller/keyboard controller (EC/KBC) 113, and an electrically erasable programmable ROM (EEPROM) 114.

The CPU 101 is a processor for controlling the operation of the respective components in the computer 10. The CPU 101 executes an operating system (OS) 201, an e-mail transmission control program 202 and various application programs, which are loaded from the HDD 109 into the main memory 103. The e-mail transmission control program 202 is software for controlling the transmission of an e-mail which is transmitted from the computer 10. When the transmission of an e-mail (also referred to as “mail”) has been instructed, the e-mail transmission control program 202 controls the transmission of the e-mail in accordance with its destination, before the e-mail is transmitted. The e-mail transmission control program 202 may be embedded in a mailer program which is executed on the computer 10.

Besides, the CPU 101 executes a BIOS that is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of executing communication with the GPU 105 via, e.g. a PCI EXPRESS serial bus.

The GPU 105 is a display controller which controls the LCD 17 that is used as a display monitor of the computer 10. A display signal, which is generated by the GPU 105, is sent to the LCD 17.

The south bridge 104 controls devices on a peripheral component interconnect (PCI) bus and devices on a low pin count (LPC) bus. The south bridge 104 includes an integrated drive electronics (IDE) controller for controlling the HDD 109 and ODD 110. The south bridge 104 also has a function of communicating with the sound controller 106.

The sound controller 106 is a sound source device and outputs audio data, which is a target of playback, to the speakers 18A and 18B. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11g standard. The USB controller 111A communicates with an external device which supports, e.g. the USB 2.0 standard (the external device is connected via the USB connector 19).

The EC/KBC 113 is a one-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 14.

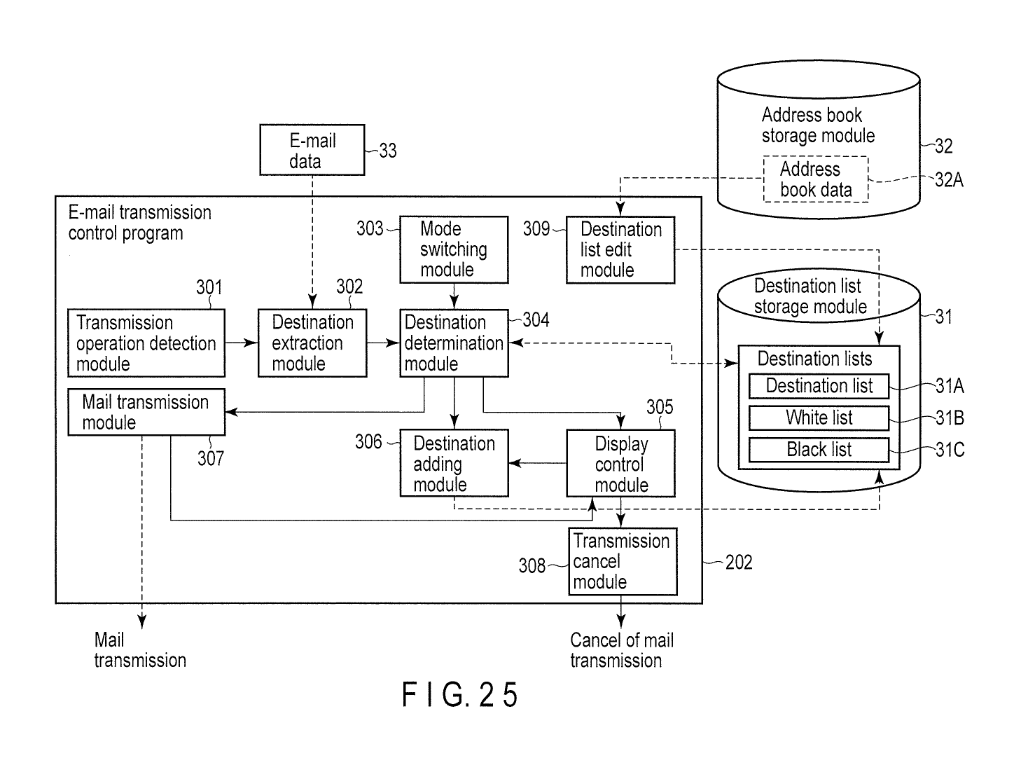

Next, referring to FIG. 25, the functional structure of the e-mail transmission control program 202 is described. The e-mail transmission control program 202 operates in cooperation with, for example, a mailer program having a function of creating an e-mail and transmitting the e-mail. In the meantime, the structure of the e-mail transmission control program 202 may be embedded in the mailer program.

The e-mail transmission control program 202 includes a transmission operation detection module 301, a destination extraction module 302, a mode switching module 303, a destination determination module 304, a display control module 305, a destination adding module 306, a mail transmission module 307, and a transmission cancel module 308. The e-mail transmission control program 202 executes data read/write from/in an address book storage module 32 and a destination list storage module 31 which are provided in a storage device (e.g. HDD 109). Address book data 32A is stored in the address book storage module 32. In addition, destination address lists 31A, 31B and 31C (also referred to as “destination lists”) are stored in the destination list storage module 31.

In the e-mail transmission control program 202, like the first embodiment, the processes in the monitoring mode, alert mode and block mode are realized by the transmission operation detection module 301, destination extraction module 302, mode switching module 303, destination determination module 304, display control module 305, destination adding module 306, mail transmission module 307 and transmission cancel module 308.

A destination list edit module 309 may input e-mail addresses which serve as default values of the destination address list 31A, by using the address book data 32A stored in the address book storage module 32. The address book data 32A includes, for example, e-mail addresses which are registered in an address book that is used in the mailer program, etc. The destination list edit module 309 reads e-mail addresses included in the address book data 32A, and adds the read e-mail addresses to the destination address list 31A.

In the meantime, the server device 50 and client device 60, which constitute the communication control system 5 according to the first embodiment, can be realized by the same configuration as the system configuration described with reference to FIG. 23 and FIG. 24.

As has been described above, according to the present embodiment, the transmission of e-mails can be controlled in accordance with the condition of use of e-mails by the user. In the embodiment, in the alert mode, an alert is issued on the transmission of an e-mail to an e-mail address which is not included in the destination address list. In the block mode, the transmission of an e-mail to an e-mail address, which is not included in the white list, or to an e-mail address, which is included in the black list, is blocked. In the monitoring mode, a destination e-mail address indicative of the destination of an e-mail is added to the destination address list. By switching the operation mode between these modes, the transmission of e-mails can be controlled in accordance with the condition of use of e-mails by the user.

All the procedures of the list delivery process and the transmission control process of the above-described embodiment can be executed by software. Thus, the same advantageous effects as with the present embodiment can easily be obtained simply by installing a computer program, which executes the procedures of the list delivery process and the transmission control process, into an ordinary computer through a computer-readable storage medium, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first list storage configured to store a destination address list comprising a first destination electronic mail address indicative of a destination of a first electronic mail which has already transmitted;
a second list storage configured to store at least one of a white list and a black list, the white list comprising a permit electronic mail address to which transmission of an electronic mail is permitted, the black list comprising a block electronic mail address to which transmission of an electronic mail is blocked; and
a transmission control module configured to block transmission of a second electronic mail to a second destination electronic mail address if the second destination electronic mail address is not included in the white list or the second destination electronic mail address is included in the black list in a block mode and configured to issue an alert on the transmission of the second electronic mail to the second destination electronic mail address if the second destination electronic mail address is not included in the destination address list in an alert mode.

2. The electronic apparatus of claim 1, further comprising a reception module configured to receive mode information transmitted from a server apparatus, the mode information designating either the alert mode or the block mode,
wherein the transmission control module is configured to operate in the mode designated in the mode information.

3. The electronic apparatus of claim 2, wherein the reception module is configured to further receive the destination address list, the white list and the black list from the server apparatus,
the first list storage is configured to store the received destination address list, and
the second list storage is configured to store the received white list and black list.

4. The electronic apparatus of claim 1, wherein the second electronic mail is transmitted to a plurality of destination electronic mail addresses, and
the transmission control module is configured to transmit the second electronic mail to a third destination electronic mail address of the plurality of destination electronic mail addresses if the third destination electronic mail address is included in the white list or the third destination electronic mail address is not included in the black list in the block mode and configured not to transmit the second electronic mail to a fourth destination electronic mail address of the plurality of destination electronic mail addresses if the fourth destination electronic mail address is not included in the white list or the fourth destination electronic mail address is included in the black list in the block mode.

5. The electronic apparatus of claim 1, wherein the transmission control module is further configured to add the second destination electronic mail address to the destination address list in a monitoring mode.

6. The electronic apparatus of claim 5, further comprising a reception module configured to receive mode information transmitted from a server apparatus, the mode information designating one of the alert mode, the block mode and the monitoring mode,
wherein the transmission control module is configured to operate in the mode designated in the mode information.

7. The electronic apparatus of claim 1, further comprising a display module configured to display a select screen if the second destination electronic mail address of the second electronic mail is not included in the destination address list in the alert mode, the select screen being for selecting whether to transmit the second electronic mail to the second destination electronic mail address,
wherein the transmission control module is configured to add the second destination electronic mail address to the destination address list and to transmit the second electronic mail to the second destination electronic mail address if to transmit the second electronic mail has been selected, and configured not to transmit the second electronic mail to the second destination electronic mail address if not to transmit the second electronic mail has been selected.

8. The electronic apparatus of claim 1, further comprising a list edit module configured to display an edit screen for editing at least one of the destination address list, the white list and the black list, and to edit the destination address list, the white list and the black list in accordance with an input with use of the edit screen.

9. An electronic apparatus comprising:
a list creation module configured to create a destination address list, a white list and a black list, the destination address list comprising a first destination electronic mail address indicative of a destination of a first electronic mail which has already transmitted, the white list comprising a permit electronic mail address to which transmission of an electronic mail is permitted, the black list comprising a block electronic mail address to which transmission of an electronic mail is blocked;
a mode determination module configured to determine whether to operate a client apparatus in a block mode or in an alert mode, the client apparatus blocking transmission of a second electronic mail to a second destination electronic mail address if the second destination electronic mail address is not included in the white list or the second destination electronic mail address is included in the black list in the block mode and issuing an alert on the transmission of the second electronic mail to the second destination electronic mail address if the second destination electronic mail address is not included in the destination address list in the alert mode; and
a transmission module configured to transmit mode information indicative of the determined mode, the destination address list, the white list, and the black list to the client apparatus.

10. A communication control method of controlling transmission of a second electronic mail which is transmitted by an electronic apparatus comprising a storage device configured to store a destination address list, a white list and a black list, the destination address list comprising a first destination electronic mail address indicative of a destination of a first electronic mail which has already transmitted, the white list comprising a permit electronic mail address to which transmission of an electronic mail is permitted, the black list comprising a block electronic mail address to which transmission of an electronic mail is blocked, the method comprising:
blocking transmission of the second electronic mail to a second destination electronic mail address if the second destination electronic mail address is not included in the white list or the second destination electronic mail address is included in the black list in a block mode; and
issuing an alert on the transmission of the second electronic mail to the second destination electronic mail address if the second destination electronic mail address is not included in the destination address list in an alert mode.

11. A communication control system comprising a server apparatus and a client apparatus which are interconnected via a network,
the server apparatus being configured to create a destination address list, a white list and a black list and to transmit the destination address list, the white list and the black list to the client apparatus, the destination address list comprising a first destination electronic mail address indicative of a destination of a first electronic mail which has already transmitted, the white list comprising a permit electronic mail address to which transmission of an electronic mail is permitted, the black list comprising a block electronic mail address to which transmission of an electronic mail is blocked, and
the client apparatus being configured to receive the destination address list, the white list and the black list from the server apparatus, to block transmission of a second electronic mail to a second destination electronic mail address if the second destination electronic mail address is not included in the white list or the second destination electronic mail address is included in the black list in a block mode, and to issue an alert on the transmission of the second electronic mail to the second destination electronic mail address if the second destination electronic mail address is not included in the destination address list in an alert mode.
